(19) United States
(12) Patent Application Publication
(10) Pub. No.: US 2020/0347763 A1
(43) Pub. Date: Nov. 5, 2020

(54) NIOBIUM OXIDE DOPED MATERIALS AS RHODIUM SUPPORTS FOR THREE-WAY CATALYST APPLICATION

(71) Applicant: BASF CORPORATION, FLORHAM PARK, NJ (US)

(72) Inventors: Fudong Liu, Oviedo, FL (US); Michel Deeba, East Brunswick, NJ (US)

(73) Assignee: BASF CORPORATION, FLORHAM PARK, NJ (US)

(21) Appl. No.: 16/758,623

(22) PCT Filed: Aug. 27, 2018
(86) PCT No.: PCT/IB2018/056528

§ 371 Date: Apr. 23, 2020

Related U.S. Application Data
(60) Provisional application No. 62/580,606, filed on Nov. 2, 2017.

(51) Int. Cl. F01N 3/10; B01J 23/46; B01J 6/00; B01J 35/04; B01J 37/02; F01N 3/28

(52) U.S. Cl. CPC F01N 3/101; B01J 23/464; B01J 6/001; B01J 35/04; B01J 21/04; F01N 3/2807; F01N 2370/02; F01N 2570/14; B01J 37/0201

(57) ABSTRACT

The present disclosure generally provides catalyst compositions, articles and methods for reducing levels of HC, CO and NOₓ in an exhaust gas stream using the catalyst compositions and catalytic articles. The compositions, which are doped with niobium oxide, significantly improve the performance of a three-way catalyst when used as the rhodium support while strictly controlling the amount of precious metal loading.

### FIELD OF THE INVENTION

The present disclosure relates generally to the field of selective catalytic reduction, and preferably to three-way conversion catalysts for gasoline emission control. More particularly, the disclosure relates to catalytic compositions and methods for effective removal of at least a portion of nitrogen oxide (NOₓ), carbon monoxide (CO), and hydrocarbon (HC) emissions from automotive exhaust.

### BACKGROUND OF THE INVENTION

Exhaust gas from vehicles powered by gasoline engines is typically treated with one or more three-way conversion (TWC) automotive catalysts, which are effective to abate nitrogen oxides (NOₓ), carbon monoxide (CO), and hydrocarbon (HC) pollutants in the exhaust of engines operated at or near stoichiometric air/fuel conditions. The precise proportion of air to fuel which results in stoichiometric conditions varies with the relative proportions of carbon and hydrogen in the fuel. An air-to-fuel (A/F) ratio is the mass ratio of air to fuel present in a combustion process such as in an internal combustion engine. The stoichiometric A/F ratio corresponds to the complete combustion of a hydrocarbon fuel, such as gasoline, to carbon dioxide (CO₂) and water. The symbol λ is thus used to represent the result of dividing a particular A/F ratio by the stoichiometric A/F ratio for a given fuel, so that: λ=1 is a stoichiometric mixture, λ>1 is a fuel-lean mixture, and λ<1 is a fuel-rich mixture.

Conventional gasoline engines having electronic fuel injection and air intake systems provide a continually varying air-fuel mixture that quickly and constantly cycles between lean and rich exhaust. Recently, to improve fuel-economy, gasoline-fueled engines are being designed to operate under slightly lean conditions. Lean conditions refers to maintaining the ratio of air to fuel in the combustion mixtures supplied to such engines above the stoichiometric ratio so that the resulting exhaust gases are “lean,” (i.e., the exhaust gases are relatively high in oxygen content). Lean burn gasoline direct injection (GDI) engines offer fuel efficiency benefits that can contribute to a reduction in greenhouse gas emissions carrying out fuel combustion in excess air.

Exhaust gas from vehicles powered by lean burn gasoline engines is typically treated with a TWC catalyst, which is effective to abate CO and HC pollutants in the exhaust of engines operated under lean conditions. Emission of NOₓ also must be reduced to meet emission regulation standards. TWC catalysts, however, are not effective for reducing NOₓ emissions when the gasoline engine runs lean. There is a continuing need in the art for TWC catalysts effective in abating NOₓ emissions from lean burn gasoline engines while also exhibiting sufficient high temperature thermal stability.

Niobium pentoxide (Nb₂O₅) is an acidic inorganic compound showing a certain degree of redox ability when combined with other oxides either in the supported form or in the mixed oxide/solid solution form (Catalysis Today 28 (1996) 199-205). In the environmental catalysis field, this material is sometimes used as the catalyst component for the selective catalytic reduction of NOₓ with NH₃ (NH₃—SCR), such as Nb₂O₅—V₂O₅/TiO₂ (Catalysis Letters 25 (1994) 49-54), Nb₂O₅—VOₓCeO₂ (RSC Adv., 2015, 5, 37675-37681), Nb₂O₅—MnOₓ—CeO₂ (Applied Catalysis B Environmental 88 (2009) 413-419; J. Phys. Chem. C, 2010, 114 (21), 9791-9801), Mn₂NbOₓ (Chemical Engineering Journal 250 (2014) 390-398), Nb₂O₅—CeO₂ (Applied Catalysis B Environmental 103 (2011) 79-84) and Nb₂O₅—CeO₂—ZrO₂ (Applied Catalysis B: Environmental 180 (2016) 766-774).

Some literature and patents also disclose that Nb₂O₅ may be utilized as an oxygen storage component (OSC) in combination with Ce/Zr oxides in TWC application for gasoline engine exhaust treatment. For example, U.S. Pat. No. 6,468,941 discloses that Nb₂O₅—CeO₂—ZrO₂ with other dopants (like yttrium, magnesium, calcium, strontium, lanthanum, praseodymium, neodymium) could be applied as an OSC material. Further disclosed is that a Nb₂O₅—CeO₂—ZrO₂—Y₂O₃ material had higher rates and extents of reduction and oxidation than the baseline niobium-free material during redox cycling tests (Applied Catalysis B Environmental 158-159 (2014) 106-111).

U.S. Patent Application Publication No. 2014/0302983 discloses that Nb₂O₅—ZrO₂ in combination of Al₂O₃, CeO₂ and SnO₂ could be applied as a TWC catalyst. Cu—Mn spinel oxide deposited on Nb₂O₅—ZrO₂ has also been suggested as an OSC material for TWC application (U.S. Pat. No. 9,48,6784; U.S. Patent Application Publication Nos. 2015/148222 and 2015/148224). Further disclosed is that Nb—Zr—Al mixed oxide (20 wt. % to 80 wt. %) in combination of CeO₂—ZrO₂—Nd₂O₃—Y₂O₃ OSC material (0 wt. % to 80 wt. %), possibly with additional NiO, may be used in the Rh overcoat layer with high TWC performance, and the optimal composition of the Nb—Zr—Al oxide mixture could be 10 wt. % Nb₂O₅, 20 wt. % ZrO₂ and 70 wt. % Al₂O₃ (U.S. Patent Application Publication Nos. 2015/0352494 and 2016/0354765).

Notably, the zoned or uniform catalyst systems disclosed in the art always have one or more of a washcoat layer, an impregnation layer, and/or an overcoat layer (Nb—Zr—Al+OSC+NiO) directly using rhodium nitrate in a slurry with pH controlled surface adsorption. In such an overcoat layer, Rh could possibly be loaded onto every component with no accurate control of Rh dispersion and Rh-support interactions. Therefore, a need exists for novel three-way catalyst compositions and catalytic articles with controlled rhodium loading, thermal stability and increased activity for removal of nitrogen oxides (NOₓ), carbon monoxide (CO), and hydrocarbon (HC) pollutants from gasoline engine exhaust streams.

### SUMMARY OF THE INVENTION

The present disclosure generally provides catalyst compositions and articles which are particularly useful in gasoline internal combustion engine Three-Way Catalyst (TWC) applications. In particular, the present disclosure provides a new Rh component support comprising a niobium oxide (e.g., Nb₂O₅) dopant incorporated into porous, highly stabilized, high surface area refractory oxides such as ZrO₂, Al₂O₃, SiO₂ and TiO₂, to effectively remove at least a portion of nitrogen oxides (NOₓ), carbon monoxide (CO), and hydrocarbon (HC) emissions from automotive exhaust. In addition to catalyst compositions, the present disclosure provides methods of preparation, such as incipient wetness impregnation or co-precipitation, to introduce the niobium oxide dopant into ZrO₂, Al₂O₃ or TiO₂ based materials as Rh component supports. Using these niobium oxide-doped materials as Rh component supports, TWC performance can be greatly improved to meet tighter emission regulations without increasing the loading of precious metals such as rhodium.

Accordingly, in one aspect of the invention is provided a catalyst composition for treating an exhaust stream of an internal combustion engine, the composition comprising a metal oxide-based support including a dopant comprising niobium oxide and at least one refractory metal oxide selected from the group consisting of alumina, zirconia, silica, titania, and combinations thereof; and a rhodium component supported on the metal oxide-based support.

In some embodiments, the metal oxide-based support comprises a further dopant that is a metal oxide selected from the group consisting of lanthanum oxide, neodymium oxide, praseodymium oxide, yttrium oxide, barium oxide, cerium oxide and combinations thereof. In a preferred embodiment, the further dopant comprises one or both of lanthanum oxide and barium oxide.

In some embodiments, the niobium oxide is present in an amount of about 0.5 to about 20% by weight based on the total weight of the metal oxide based support. In a preferred embodiment, the niobium oxide is present in amount of about 1 to about 10% by weight based on the total weight of the metal oxide based support.

In some embodiments, the rhodium component is present in an amount of about 0.01 to about 5% by weight based on the total weight of the catalyst composition. In some embodiments, the rhodium component is selected from the group consisting of rhodium, rhodium oxide, and mixtures thereof.

In some embodiments, the at least one refractory metal oxide is impregnated with the dopant. In some embodiments, the at least one refractory metal oxide and the dopant are in the form of a co-precipitant.

In another aspect is provided a catalyst article for treating an exhaust stream of an internal combustion engine, the catalyst article comprising a catalyst substrate and a first washcoat of the catalyst composition of the present invention on at least a portion of the catalyst substrate.

In some embodiments, the catalyst article further comprises a second washcoat of a second, different catalyst composition on at least a portion of the catalyst substrate. In some embodiments, the first washcoat is a topcoat, the second washcoat is a bottom coat, and the first washcoat is present over at least a portion of the second washcoat. In some embodiments, the first washcoat comprises at least one further catalyst composition comprising at least one refractory metal oxide on a metal oxide-based support selected from the group consisting of alumina, zirconia, silica, titania, and combinations thereof, the at least one further catalyst composition not including the niobium oxide dopant. In some embodiments, the at least one further catalyst composition present in the first washcoat includes a rhodium component. In some embodiments, the first washcoat comprises a rhodium component, lanthanum oxide, barium oxide, and at least one of zirconium oxide and aluminum oxide. In some embodiments, the second washcoat comprises a platinum group metal (PGM). In some embodiments, the second washcoat comprises a PGM on a support that is a refractory metal oxide selected from the group consisting of alumina, zirconia, silica, titania, and combinations thereof. In some embodiments, the second washcoat comprises a PGM on a support that is an oxygen storage component. In some embodiments, the second washcoat comprises lanthanum oxide, cerium oxide, barium oxide, and at least one of zirconium oxide and aluminum oxide. In some embodiments, the catalyst composition of the first washcoat is present on the catalyst substrate with a loading of at least about 1.0 g/in³. In some embodiments, the catalyst substrate is a honeycomb comprising a wall flow filter substrate or a flow through substrate.

In a further aspect is provided a method for reducing a NOₓ level in an exhaust gas, the method comprising contacting the gas with a catalyst composition of the present invention for a time and temperature sufficient to reduce the level of NOₓ in the gas.

In a further aspect is provided a method for reducing a CO, NOₓ and/or HC level in an exhaust gas, the method comprising contacting the exhaust gas with a catalyst composition of the present invention for a time and temperature sufficient to reduce the level of CO, NOₓ and/or HC in the exhaust gas.

In yet another aspect is provided a method for preparing the catalyst composition of the present invention, the method comprising loading a niobium component onto a support by the incipient wetness technique; calcining the resulting niobium impregnated material at a temperature from about 400 to about 700° C.; impregnating the calcined material with the rhodium component; and calcining the resulting material at a temperature from about 400 to about 700° C. In some embodiments, the niobium component is niobium chloride. In some embodiments, the niobium component is ammonium niobium oxalate.

In yet another aspect is provided a method for preparing a catalyst composition of the present invention, the method comprising loading a niobium component onto a support by a co-precipitation method; calcining the resulting niobium impregnated material at a temperature from about 400 to about 700° C.; impregnating the calcined material with a rhodium component; and calcining the resulting material at a temperature from about 400 to about 700° C. In some embodiments, the niobium component is niobium chloride. In some embodiments, the niobium component is ammonium niobium oxalate.

In yet another aspect is provided a method for preparing the catalyst composition of the present invention, the method comprising loading a niobium component and a rhodium component onto a support by a co-impregnation method and calcining the resulting niobium and rhodium impregnated material at a temperature from about 400 to about 700° C.

In yet another aspect is provided a method for preparing a catalyst article of the present invention, the method comprising loading a niobium component onto a support by an incipient wetness or a co-precipitation technique; impregnating the support material with a rhodium component; dispersing the resulting rhodium impregnated support as a slurry; coating the slurry onto a substrate by chemical fixation; and calcining the resulting material at a temperature from about 400 to about 700° C.

In a final aspect is provided a four-way filter comprising the catalyst article of the present invention, wherein the catalyst substrate is a particulate filter configured to remove soot and particulate matter. The four-way filter thereby reduces a HC, CO, and/or a NOx level in an exhaust gas simultaneously with a reduction in a level of soot and/or particulate matter in the exhaust gas.

The present disclosure includes, without limitation, the following embodiments.

Embodiment 1. A catalyst composition for treating an exhaust stream of an internal combustion engine, the composition comprising a metal oxide-based support including a dopant comprising niobium oxide and at least one refractory metal oxide selected from the group consisting of alumina, zirconia, silica, titania, and combinations thereof; and a rhodium component supported on the metal oxide-based support.

Embodiment 2. The catalyst composition of the preceding embodiment, wherein the metal oxide-based support comprises a further dopant that is a metal oxide selected from the group consisting of lanthanum oxide, neodymium oxide, praseodymium oxide, yttrium oxide, barium oxide, cerium oxide and combinations thereof, preferably, wherein the further dopant comprises one or both of lanthanum oxide and barium oxide.

Embodiment 3. The catalyst composition of any preceding embodiment, wherein the niobium oxide is present in an amount of about 0.5 to about 20% by weight based on the total weight of the metal oxide based support, preferably in an amount of about 1 to about 10% by weight based on the total weight of the metal oxide based support.

Embodiment 4. The catalyst composition of any preceding embodiment, wherein the rhodium component is present in an amount of about 0.01 to about 5% by weight based on the total weight of the catalyst composition.

Embodiment 5. The catalyst composition of any preceding embodiment, wherein the rhodium component is selected from the group consisting of rhodium, rhodium oxide, and mixtures thereof.

Embodiment 6. The catalyst composition of any preceding embodiment, wherein the at least one refractory metal oxide is impregnated with the dopant.

Embodiment 7. The catalyst composition of any preceding embodiment, wherein the at least one refractory metal oxide and the dopant are in the form of a co-precipitant.

Embodiment 8. A catalyst article for treating an exhaust stream of an internal combustion engine, the catalyst article comprising a catalyst substrate; and a first washcoat of a catalyst composition according to any preceding embodiment on at least a portion of the catalyst substrate.

Embodiment 9. The catalyst article of any preceding embodiment, further comprising a second washcoat of a second, different catalyst composition on at least a portion of the catalyst substrate.

Embodiment 10. The catalyst article of any preceding embodiment, wherein the first washcoat is a topcoat, the second washcoat is a bottom coat, and the first washcoat is present over at least a portion of the second washcoat.

Embodiment 11. The catalyst article of any preceding embodiment, wherein the first washcoat comprises at least one further catalyst composition comprising at least one refractory metal oxide on a metal oxide-based support selected from the group consisting of alumina, zirconia, silica, titania, and combinations thereof, the at least one further catalyst composition not including the niobium oxide dopant.

Embodiment 12. The catalyst article of any preceding embodiment, wherein the at least one further catalyst composition present in the first washcoat includes a rhodium component.

Embodiment 13. The catalyst article of any preceding embodiment, wherein the first washcoat comprises a rhodium component, lanthanum oxide, barium oxide, and at least one of zirconium oxide and aluminum oxide.

Embodiment 14. The catalyst article of any preceding embodiment, wherein the second washcoat comprises a platinum group metal (PGM).

Embodiment 15. The catalyst article of any preceding embodiment, wherein the second washcoat comprises a PGM on a support that is a refractory metal oxide selected from the group consisting of alumina, zirconia, silica, titania, and combinations thereof.

Embodiment 16. The catalyst article of any preceding embodiment, wherein the second washcoat comprises a PGM on a support that is an oxygen storage component.

Embodiment 17. The catalyst article of any preceding embodiment, wherein the second washcoat comprises lanthanum oxide, cerium oxide, barium oxide, and at least one of zirconium oxide and aluminum oxide.

Embodiment 18. The catalyst article of any preceding embodiment, wherein the catalyst substrate is a honeycomb comprising a wall flow filter substrate or a flow through substrate.

Embodiment 19. The catalyst article of any preceding embodiment, wherein the catalyst composition of the first washcoat is present on the catalyst substrate with a loading of at least about 1.0 g/in³.

Embodiment 20. A method for reducing a NOₓ level in an exhaust gas, the method comprising contacting the gas with a catalyst for a time and temperature sufficient to reduce the level of NOₓ in the gas, wherein the catalyst is a catalyst composition according to any preceding embodiment.

Embodiment 21. A method for reducing a HC, CO and/or a NOₓ level in an exhaust gas, the method comprising contacting the gas with a catalyst for a time and temperature sufficient to reduce the level of HC, CO and/or NOₓ in the gas, wherein the catalyst is a catalyst article according to any preceding embodiment.

Embodiment 22. A method for preparing the catalyst composition of any preceding embodiment, the method comprising: loading a niobium component onto the support by an incipient wetness technique; calcining the resulting niobium impregnated material at a temperature from about 400 to about 700° C.; impregnating the calcined material with the rhodium component; and calcining the resulting material at a temperature from about 400 to about 700° C.

Embodiment 23. A method for preparing the catalyst composition of any preceding embodiment, the method comprising: loading a niobium component onto the support by a co-precipitation method; calcining the resulting niobium impregnated material at a temperature from about 400 to about 700° C.; impregnating the calcined material with the rhodium component; and calcining the resulting material at a temperature from about 400 to about 700° C.

Embodiment 24. A method for preparing the catalyst composition of any preceding embodiment, the method comprising: loading a niobium component and the rhodium component onto the support by a co-impregnation method; and calcining the resulting niobium and rhodium impregnated material at a temperature from about 400 to about 700° C.

Embodiment 25. The method of any preceding embodiment, wherein the niobium component is niobium chloride or ammonium niobium oxalate.

Embodiment 26. A method for preparing the catalyst article of any preceding embodiment, the method comprising: loading a niobium component onto the support by an incipient wetness or a co-precipitation technique; impregnating the support material resulting from step a) with a rhodium component; dispersing the resulting rhodium impregnated support as a slurry; coating the slurry onto the substrate by chemical fixation; and calcining the resulting material at a temperature from about 400 to about 700° C.

Embodiment 27. A four-way filter comprising the catalyst article of any preceding embodiment, wherein the catalyst substrate is a particulate filter configured to remove soot and particulate matter, the four-way filter thereby reducing a HC, CO, and/or a NOₓ level in an exhaust gas simultaneously with a reduction in a level of soot and/or particulate matter in the exhaust gas.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present invention will become apparent from the following.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention. The above and other features of the present disclosure, their nature, and various advantages will become more apparent upon consideration of the following detailed description, taken in conjunction with the accompanying drawings, in which:

FIG. 1 is a graphic illustration of an exemplary flow-through substrate of cylindrical form;

FIG. 2 is a graphic illustration of an exemplary flow-through substrate of cylindrical form, further illustrating details of the flow passages and washcoat layering in a longitudinal view;

FIG. 3 is a graphical representation of an exemplary substrate in the form of a wall flow filter;

FIG. 4A is a graphic illustration of the T₅₀ results of CO, NOₓ and HC during light-off tests on 950° C. aged samples with and without Nb₂O₅ doping;

FIG. 4B is a graphic illustration of the T₅₀ results of CO, NO, and HC during light-off tests on 1050° C. aged samples with and without Nb₂O₅ doping;

FIG. 5 is a graphic illustration of the NOx conversion results on 950/1050° C. aged samples with and without Nb₂O₅ doping;

FIG. 6 is a graphic illustration of a layered TWC catalyst design having Rh/La₂O₃—ZrO₂ (with and without Nb₂O₅ doping) in the top layer;

FIG. 7 is a graphic illustration of the cumulative mid-bed emission results of HC on TWC catalysts with and without Nb₂O₅ doping;

FIG. 8 is a graphic illustration of the cumulative mid-bed emission results of CO on TWC catalysts with and without Nb₂O₅ doping;

FIG. 9 is a graphic illustration of the cumulative mid-bed emission results of NOₓ on TWC catalysts with and without Nb₂O₅ doping; and

FIG. 10 is a graphic illustration of second-by-second mid-bed NOₓ concentration and catalyst bed temperature on TWC catalysts with and without Nb₂O₅ doping.

### DETAILED DESCRIPTION OF THE PREFERRED EMBODIMENTS

The use of the terms “a,” “an,” “the,” and similar referents in the context of describing the materials and methods discussed herein (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. The term “about” used throughout this specification is used to describe and account for small fluctuations. For example, the term “about” can refer to less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. This invention may be embodied in many different forms and should not be construed as limited to the embodiments set forth herein; rather, these embodiments are provided so that this disclosure will be thorough and complete, and will fully convey the scope of the invention to those skilled in the art. No language in the specification should be construed as indicating any non-claimed element as essential to the practice of the disclosed materials and methods.

The present disclosure provides a new Rh component support comprising niobium oxide incorporated into porous, highly stabilized, high surface area refractory oxides such as ZrO₂, Al₂O₃, SiO₂ and TiO₂, to effectively remove at least a portion of nitrogen oxides (NOₓ), carbon monoxide (CO), and hydrocarbon (HC) emissions from automotive exhaust. Surprisingly, it was found that doping of Nb₂O₅ into ZrO₂ or Al₂O₃ based materials, either by the method of incipient wetness impregnation or the method of co-precipitation, significantly improves the TWC performance of a catalyst composition when the doped materials are used as a Rh support. Powder catalyst testing results indicate that the Rh catalyst composition supported on Nb₂O₅ promoted materials exhibits a lower light-off temperature for HC, CO and NOₓ reduction compared to a Nb₂O₅ free catalyst composition, and the NOₓ conversion, especially on high temperature aged catalyst (1050° C.), was greatly improved in the presence of Nb₂O₅.

As used herein, the term “catalyst” or “catalyst composition” refers to a material that promotes a reaction.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

The terms “exhaust stream,” “engine exhaust stream, “exhaust gas stream” and the like refer to any combination of flowing engine effluent gas that may also contain solid or liquid particulate matter. The stream comprises gaseous components and is, for example, exhaust of a lean burn engine, which may contain certain non-gaseous components such as liquid droplets, solid particulates and the like. An exhaust stream of a lean burn engine typically further comprises combustion products, products of incomplete combustion, oxides of nitrogen, combustible and/or carbonaceous particulate matter (soot) and un-reacted oxygen and/or nitrogen. Such terms refer as well as to the effluent downstream of one or more other catalyst system components as described herein.

The term “catalytic article” or “catalyst article” refers to a component that is used to promote a desired reaction. The present catalytic articles comprise a “substrate” having at least one catalytic coating disposed thereon. For example, a catalyst article may comprise a washcoat containing catalytic compositions on a substrate.

As used herein, the term “substrate” refers to the monolithic material onto which the catalyst composition is placed, typically in the form of a washcoat containing a plurality of particles containing a catalytic composition thereon. A washcoat is formed by preparing a slurry containing a certain solid content (e.g., 30-90% by weight) of particles in a liquid vehicle, which is then coated onto a substrate and dried to provide a washcoat layer. Reference to “monolithic substrate” means a unitary structure that is homogeneous and continuous from inlet to outlet.

As used herein, the term “washcoat” has its usual meaning in the art of a thin, adherent coating of a catalytic or other material applied to a substrate material, such as a honeycomb-type carrier member, which is sufficiently porous to permit the passage of the gas stream being treated. As used herein and as described in Heck, Ronald and Farrauto, Robert, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A substrate can contain one or more washcoat layers, and each washcoat layer can be different in some way (e.g., may differ in physical properties thereof such as, for example particle size or crystallite phase) and/or may differ in the chemical catalytic functions.

The catalyst article may be “fresh” meaning it is new and has not been exposed to any heat or thermal stress for a prolonged period of time. “Fresh” may also mean that the catalyst was recently prepared and has not been exposed to any exhaust gases. Likewise, an “aged” catalyst article is not new and has been exposed to exhaust gases and elevated temperature (i.e. greater than 500° C.) for a prolonged period of time (i.e., greater than 3 hours).

A “support” in a catalytic material or catalyst washcoat refers to a material that receives metals (e.g., PGMs), stabilizers, promoters, binders, and the like through precipitation, association, dispersion, impregnation, or other suitable methods. Exemplary supports include refractory metal oxide supports as described herein below.

“Refractory metal oxide supports” are metal oxides including, for example, bulk alumina, ceria, zirconia, titania, silica, magnesia, neodymia, and other materials known for such use, as well as physical mixtures or chemical combinations thereof, including atomically-doped combinations and including high surface area or activated compounds such as activated alumina. Exemplary combinations of metal oxides include alumina-zirconia, alumina-ceria-zirconia, lanthana-alumina, lanthana-zirconia-alumina, baria-alumina, baria-lanthana-alumina, baria-lanthana-neodymia alumina, and alumina-ceria. Exemplary aluminas include large pore boehmite, gamma-alumina, and delta/theta alumina. Useful commercial aluminas used as starting materials in exemplary processes include activated aluminas, such as high bulk density gamma-alumina, low or medium bulk density large pore gamma-alumina, and low bulk density large pore boehmite and gamma-alumina. Such materials are generally considered as providing durability to the resulting catalyst.

“High surface area refractory metal oxide supports” refer specifically to support particles having pores larger than 20 Å and a wide pore distribution. High surface area refractory metal oxide supports, e.g., alumina support materials, also referred to as “gamma alumina” or “activated alumina,” typically exhibit a BET surface area of fresh material in excess of 60 square meters per gram (“m²/g”), often up to about 200 m²/g or higher. Such activated alumina is usually a mixture of the gamma and delta phases of alumina, but may also contain substantial amounts of eta, kappa and theta alumina phases.

Weight percent (wt. %), if not otherwise indicated, is based on an entire composition free of any volatiles; that is, based on solids content. In reference to the platinum group metal component, wt. % refers to the metal on a dry basis after calcination.

The term “NOₓ” refers to nitrogen oxide compounds, such as NO or NO₂.

As used herein, the term “oxygen storage component” (OSC) refers to an entity that has a multi-valence state and can actively react with reductants such as carbon monoxide (CO) and/or hydrogen under reduction conditions and then react with oxidants such as oxygen or nitrogen oxides under oxidative conditions. Examples of oxygen storage components include rare earth oxides, particularly ceria, lanthana, praseodymia, neodymia, niobia, europia, samaria, ytterbia, yttria, zirconia, and mixtures thereof in addition to ceria.

A platinum group metal (PGM) component refers to any component that includes a PGM (Ru, Rh, Os, Ir, Pd, Pt and/or Au). For example, the PGM may be in metallic form, with zero valence, or the PGM may be in an oxide form. Reference to “PGM component” allows for the presence of the PGM in any valence state. The terms “platinum (Pt) component,” “rhodium (Rh) component,” “palladium (Pd) component,” “iridium (Ir) component,” “ruthenium (Ru) component,” and the like refer to the respective platinum group metal compound, complex, or the like which, upon calcination or use of the catalyst, decomposes or otherwise converts to a catalytically active form, usually the metal or the metal oxide.

As used herein, the term “promoter” and the term “dopant” may be used interchangeably, both referring to a component that is intentionally added to the support material to enhance an activity of a catalyst as compared to a catalyst that does not have a promoter or dopant intentionally added. In the present disclosure, an exemplary dopant is niobium oxide. In the present disclosure, exemplary dopants are oxides of metals such as lanthanum, neodymium, praseodymium, yttrium, barium, cerium and combinations thereof.

### I. Catalyst Composition

In one aspect of the invention is provided a catalyst composition for treating an exhaust stream of an internal combustion engine, the composition comprising a promoted metal oxide-based support with a rhodium component supported thereon. The dopant for the promoted metal oxide-based support particularly comprises niobium oxide. The metal oxide-based support specifically comprises a refractory metal oxide selected from the group consisting of alumina, zirconia, silica, titania, and combinations thereof.

Metal oxide-based supports, can, in some embodiments, be described as being highly stable. By “highly stable” in this context is meant that the decrease in BET surface area is less than about 60% and the decrease in pore volume is less than about 10% after the material is calcined at a temperature of, for example, from about 850° C. to about 1050° C. for 20 hours with 10% water/steam in air. The metal oxide-based support may comprise a fresh surface area that is in the range of about 40 to about 200 m²/g. The metal oxide-based support may comprise a surface area that is in the range of about 20 to about 140 m²/g after aging at a temperature of, for example, from about 850° C. to about 1050° C. for 20 hours with 10% water/steam in air. The metal oxide-based support may have an average crystallite size in the range of about 3 to about 20 nm measured by x-ray diffraction (XRD). The metal oxide-based support may comprise an x-ray diffraction crystallite size ratio of aged material to fresh material of about 2.5 or less, where aging is at a temperature of, for example, from about 850° C. to about 1050° C. for a period of about 20 hours with 10% water/steam in air. In some embodiments, the metal oxide based support can exhibit one or more than one (including all) of the characteristics referenced in this and the preceding paragraphs.

Pore volumes of certain preferred fresh metal oxide-based supports are at least about 0.20 cm³/g. In certain embodiments, the pore volume of the fresh metal oxide-based supports is in the range of about 0.20 to 0.40 cm³/g. Surface areas of other preferred fresh metal oxide-based supports are at least about 40 m²/g and in some embodiments, may be at least about 60 m²/g, at least about 80 m²/g, or at least about 100 m²/g. In certain embodiments, surface areas of the fresh ceria-based supports are in the range of about 40 to about 200 m²/g, and in some embodiments, in the range of about 100 to about 180 m²/g.

In some embodiments, the metal oxide-based support comprises a further dopant that is a metal oxide selected from the group consisting of lanthanum oxide, neodymium oxide, praseodymium oxide, yttrium oxide, barium oxide, cerium oxide and combinations thereof. In a preferred embodiment, the further dopant comprises one or both of lanthanum oxide and barium oxide.

In some embodiments, the niobium oxide is present in an amount of about 0.5 to about 20% by weight based on the total weight of the metal oxide based support. In a preferred embodiment the niobium oxide is present in amount of about 1 to about 10% or about 2 to about 8% by weight based on the total weight of the metal oxide based support.

In some embodiments, the rhodium component is present in an amount of about 0.01 to about 5%, about 0.04 to about 3%, or about 0.1 to about 2% by weight on a metal basis based on the total weight of the catalyst composition. In some embodiments, the rhodium component is selected from the group consisting of rhodium, rhodium oxide, and mixtures thereof.

In some embodiments, the at least one refractory metal oxide is impregnated with the dopant. As such, the dopant may be added to a previously formed refractory metal oxide material utilizing impregnation methods as otherwise described herein.

In some embodiments, the at least one refractory metal oxide and the dopant are in the form of a co-precipitant. For example, metal precursor compounds for the refractory metal oxide and the dopant can be combined in solution, and a precipitating agent can be added. For example, a pH-adjusting agent may be used as the precipitating agent. The precipitating agent can be effective to co-precipitate the metal species from the solution. As such, the dopant component is intermixed with the refractory metal oxide support material and simultaneously formed into a unitary body. It is thus understood that a co-precipitant, because of the intermixture of materials arising during co-precipitation, can exhibit different properties from a material wherein the dopant is impregnated into a previously formed refractory metal oxide material.

A catalyst composition as described herein can provide improved properties in relation to similar catalyst compositions that do not include a dopant. As described more fully in the Examples, the present catalyst compositions can provide improved NOₓ conversion as well as improved performance in relation to CO and hydrocarbons (HC).

### Preparation of Catalyst Compositions

The preparation of the catalyst composition as described herein generally comprises treating (impregnating) a metal oxide-based support with a niobium component. The niobium component may be any salt of niobium which provides niobium oxide upon calcination, for example, ammonium niobium oxalate or niobium chloride. The loading of the niobium component may vary. In some embodiments, the niobium loading (as niobium oxide, Nb₂O₅) is from about 0.5 to about 20 wt. % based on the total weight of the support. In some embodiments, the niobium loading is from about 5 to about 10 wt. %. In some embodiments, the impregnation method is the incipient wetness technique. In some embodiments, the impregnation method used is the co-precipitation method. Such techniques are known to those skilled in the art and are disclosed in, for example, U.S. Pat. Nos. 6,423,293; 5,898,014; and 5,057,483, each of which is incorporated by reference herein for the relevant teachings.

The preparation of the catalyst composition as described herein generally further comprises treating (impregnating) the niobium-doped metal oxide-based support in particulate form with a solution comprising a rhodium component. For the purposes herein, the term “rhodium component” means any rhodium-containing compound, salt, complex, or the like which, upon calcination or use thereof, decomposes or otherwise converts to the rhodium component. In some embodiments, the rhodium component is rhodium metal or rhodium oxide.

In general terms, the rhodium component (e.g., in the form of a solution of a rhodium salt) can be impregnated onto a metal oxide-based support (e.g., as a powder) by, for example, incipient wetness techniques. Water-soluble rhodium compounds or salts or water-dispersible compounds or complexes of the metal component may be used as long as the liquid medium used to impregnate or deposit the metal component onto the support particles does not adversely react with the metal or its compound or its complex or other components which may be present in the catalyst composition and is capable of being removed by volatilization or decomposition upon heating and/or application of a vacuum. Generally, both from the point of view of economics and environmental aspects, aqueous solutions of soluble compounds, salts, or complexes of the rhodium component are advantageously utilized. In some embodiments, the rhodium component and the niobium component are loaded onto the support by the co-impregnation method. The co-impregnation technique is known to those skilled in the art and is disclosed in, for example, U.S. Pat. No. 7,943,548, which is incorporated by reference herein for the relevant teachings.

Thereafter, the rhodium-impregnated metal oxide-based support is generally calcined. An exemplary calcination process involves heat treatment in air at a temperature of about 400 to about 700° C. for about 10 minutes to about 3 hours. During the calcination step and/or during the initial phase of use of the catalytic composition, the rhodium component is converted into a catalytically active form of the metal or metal oxide thereof The above process can be repeated as needed to reach the desired level of PGM impregnation. The resulting material can be stored as a dry powder or in slurry form. In particular, the catalyst composition is particularly suitable for use in forming a washcoat composition for application to a suitable substrate for formation of a catalyst article as otherwise described herein.

### Catalyst Composition Activity

Catalyst compositions and articles as disclosed herein are effective to decompose at least a portion of the CO, NOₓ and/or HC present in an exhaust stream. By “at least a portion” is meant some percentage of the total CO, NOₓ and/or HC present in the exhaust gas stream is decomposed and/or reduced. For example, in some embodiments, at least about 1%, at least about 2%, at least about 5%, at least about 10%, at least about 20%, at least about 30%, at least about 40%, at least about 50%, at least about 60%, at least about 70%, at least about 80%, or at least about 90% by weight of the CO, NOₓ and/or HC in the gas stream is decomposed and/or reduced under such conditions. The foregoing percentages thus can relate to CO conversion alone, to NOₓ conversion alone, to HC conversion alone, to a combined conversion of CO and NOₓ, to a combined conversion of CO and HC, to a combined conversion of NOₓ and HC, or to a combined conversion of CO, NOₓ, and HC.

### II. Catalyst Articles

In another aspect is provided a catalyst article for treating an exhaust stream of an internal combustion engine, the catalyst article comprising a catalyst substrate and a first washcoat of the catalyst composition previously disclosed herein on at least a portion of the catalyst substrate.

### Substrate

In one or more embodiments, the substrate for the catalytic article disclosed herein may be constructed of any material typically used for preparing automotive catalysts and will typically comprise a metal or ceramic honeycomb structure. The substrate typically provides a plurality of wall surfaces upon which a washcoat comprising the catalyst composition is applied and adhered, thereby acting as a carrier for the catalyst composition. The catalyst composition is typically disposed on a substrate such as a monolithic substrate for exhaust gas applications. In describing the quantity of washcoat or catalytic metal components or other components of the composition, it is convenient to use units of weight of component per unit volume of catalyst substrate. Therefore, the units, grams per cubic inch (“g/in³”) and grams per cubic foot (“g/ft³”) are used herein to mean the weight of a component per volume of the substrate, including the volume of void spaces of the substrate. Other units of weight per volume such as g/L are also sometimes used. The total loading of the catalyst composition on the catalyst substrate, such as a monolithic flow-through substrate, is typically from about 0.5 to about 6 g/in³, and more typically from about 1 to about 5 g/in³. It is noted that these weights per unit volume are typically calculated by weighing the catalyst substrate before and after treatment with the catalyst washcoat composition, and since the treatment process involves drying and calcining the catalyst substrate at high temperature, these weights represent an essentially solvent-free catalyst coating as essentially all of the water of the washcoat slurry has been removed.

Any suitable substrate may be employed, such as a monolithic substrate of the type having fine, parallel gas flow passages extending therethrough from an inlet or an outlet face of the substrate, such that passages are open to fluid flow therethrough (referred to as honeycomb flow through substrates). The passages, which are essentially straight paths from their fluid inlet to their fluid outlet, are defined by walls on which the catalytic material is coated as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain from about 60 to about 900 or more gas inlet openings (i.e., cells) per square inch of cross section. Such monolithic carriers may contain up to about 1200 or more flow passages (or “cells”) per square inch of cross section, although far fewer may be used. Flow-through substrates typically have a wall thickness between 0.002 and 0.1 inches.

The substrate can also be a wall-flow filter substrate, where the channels are alternately blocked, allowing a gaseous stream entering the channels from one direction (inlet direction), to flow through the channel walls and exit from the channels from the other direction (outlet direction). The wall-flow filter substrate can be made from materials commonly known in the art, such as cordierite, aluminum titanate or silicon carbide.

The substrate may also be a particulate filter configured to remove soot and particulate matter. Use of such a substrate results with the catalyst composition of the present invention provides a four-way filter which can reduce a HC, CO, and/or a NOₓ level in an exhaust gas simultaneously with a reduction in a level of soot and/or particulate matter in the exhaust gas.

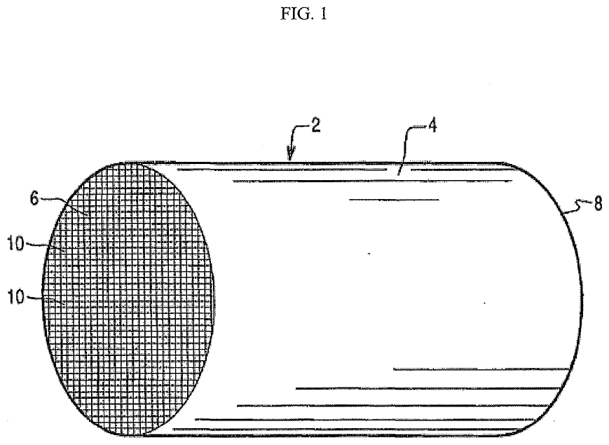

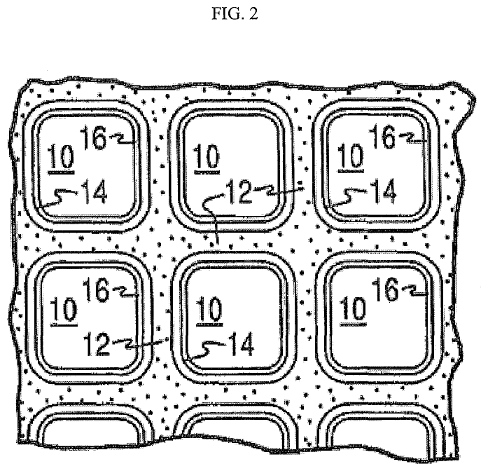

FIGS. 1 and 2 illustrate an exemplary substrate 2 in the form of a flow-through substrate coated with a washcoat composition as described herein. Referring to FIG. 1, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 2, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof As more easily seen in FIG. 2, walls 12 are so dimensioned and configured that gas flow passages 10 have a substantially regular polygonal shape. As shown, the washcoat composition can be applied in multiple, distinct layers if desired. In the illustrated embodiment, the washcoat consists of both a discrete bottom washcoat layer 14 adhered to the walls 12 of the carrier member and a second discrete top washcoat layer 16 coated over the bottom washcoat layer 14. The present invention can be practiced with one or more (e.g., 2, 3, or 4) washcoat layers and is not limited to the illustrated two-layer embodiment.

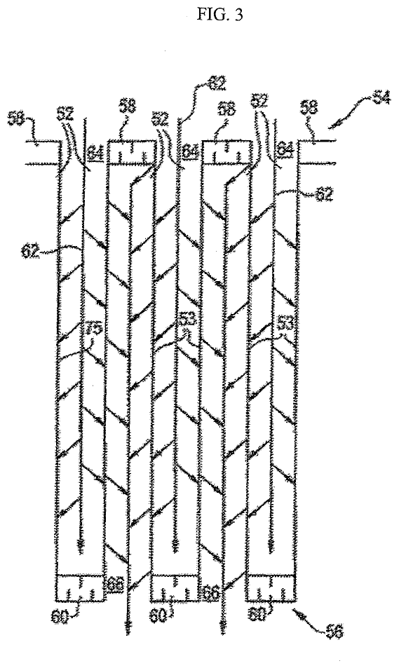

Alternatively, FIGS. 1 and 3 can illustrate an exemplary substrate 2 in the form of a wall flow filter substrate coated with a washcoat composition as described herein. As seen in FIG. 3, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58, and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalyzed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic material on the inlet and/or outlet walls of the element.

The substrate may be made of any suitable refractory material, e.g., cordierite, cordierite-alumina, silicon carbide, aluminum titanate, zircon mullite, spodumene, alumina-silica magnesia, zircon silicate, sillimanite, a magnesium silicate, zircon, petalite, alumina, an aluminosilicate and the like, or combinations thereof The substrates useful for the catalytic article of the present invention may also be metallic in nature and be composed of one or more metals or metal alloys. The metallic substrates may be employed in various shapes such as corrugated sheet or monolithic form. Preferred metallic supports include the heat resistant metals and metal alloys such as titanium and stainless steel as well as other alloys in which iron is a substantial or major component. Such alloys may contain one or more of nickel, chromium and/or aluminum, and the total amount of these metals may advantageously comprise at least 15 wt. % of the alloy, e.g., 10-25 wt. % of chromium, 3-8 wt. % of aluminum and up to 20 wt. % of nickel. The alloys may also contain small or trace amounts of one or more other metals such as manganese, copper, vanadium, titanium and the like. The surface of the metal substrates may be oxidized at high temperatures, e.g., 1000° C. and higher, to improve the resistance to corrosion of the alloys by forming an oxide layer on the surfaces of the substrates/carriers. Such high temperature-induced oxidation may enhance the adherence of the refractory metal oxide support and catalytically promoting metal components to the substrate. In some embodiments, the substrate is a flow through or wall-flow filter comprising metallic fibers.

In some embodiments, the substrate (for example, a flow through or wall-flow filter) is coated with a washcoat of a catalyst composition as described herein, the catalyst composition comprising a niobium oxide-promoted metal oxide-based support with a rhodium component supported thereon. In some embodiments, the metal oxide-based support comprises a refractory metal oxide selected from the group consisting of alumina, zirconia, silica, titania, and combinations thereof In some embodiments, the washcoat comprises a rhodium component supported on a niobium oxide-promoted zirconia or alumina support. In some embodiments, the washcoat comprises a further dopant that is a metal oxide selected from the group consisting of lanthanum oxide, neodymium oxide, praseodymium oxide, yttrium oxide, barium oxide, cerium oxide and combinations thereof In some embodiments, the washcoat comprises a rhodium component, lanthanum oxide, niobium oxide, and at least one of zirconium oxide and aluminum oxide. In some embodiments, the washcoat comprises a rhodium component, lanthanum oxide, barium oxide, niobium oxide, and at least one of zirconium oxide and aluminum oxide. In some embodiments, the washcoat comprises a rhodium component, barium oxide, niobium oxide, and at least one of zirconium oxide and aluminum oxide. In some embodiments, the catalyst composition of the washcoat is present on the catalyst substrate with a loading of at least about 1.0 g/in³. In some embodiments, the catalyst substrate is a honeycomb comprising a wall flow filter substrate or a flow through substrate.

In some embodiments, the catalyst article further comprises a second washcoat of a second, different catalyst composition on at least a portion of the catalyst substrate. In some embodiments, the first washcoat comprises at least one further catalyst composition comprising at least one refractory metal oxide on a metal oxide-based support selected from the group consisting of alumina, zirconia, silica, titania, and combinations thereof, the at least one further catalyst composition not including a niobium oxide dopant. In some embodiments, the at least one further catalyst composition present in the first washcoat includes a rhodium component. In some embodiments, the first washcoat comprises a rhodium component, lanthanum oxide, barium oxide, and at least one of zirconium oxide and aluminum oxide.

In some embodiments, the second washcoat comprises a platinum group metal (PGM). In some embodiments, the PGM is palladium. In some embodiments, the second washcoat comprises a PGM on a support that is a refractory metal oxide selected from the group consisting of alumina, zirconia, silica, titania, and combinations thereof. In some embodiments, the second washcoat comprises a PGM on a support that is an oxygen storage component. In some embodiments, the second washcoat comprises lanthanum oxide, cerium oxide, barium oxide, and at least one of zirconium oxide and aluminum oxide.

The relationship of the first and second washcoats with respect to one another can vary. The washcoats can, in some embodiments, be in layered form. For example, in some embodiments, the washcoats of the catalyst compositions are in layered form, such that the first washcoat is disposed on the substrate as a first layer and the second washcoat is overlying at least a portion of the first washcoat as a second layer. In other embodiments, the washcoats of the catalyst compositions are in layered form, such that the second washcoat is disposed on the substrate as a first layer and the first washcoat is overlying at least a portion of the second washcoat as a second layer.

It is noted that the catalyst article is not limited to this layered embodiment. In some embodiments, the two washcoats are provided in zoned (e.g., laterally zoned) configuration with respect to one another. As used herein, the term “laterally zoned” refers to the location of the first and second washcoats relative to one another, as applied on one or more substrates. Lateral means side-by-side, such that the first and second washcoats are located one beside the other. In some embodiments, the substrate can be coated with at least two layers contained in separate washcoat slurries in a laterally zoned configuration. For example, the same substrate can be coated with a washcoat slurry of one layer and a washcoat slurry of another layer, wherein each layer is different. In one or more embodiments, the catalytic article is in a laterally zoned configuration wherein the first composition is coated on a substrate upstream of the second composition. In other embodiments, the catalytic article is in a laterally zoned configuration wherein the first composition is coated on a substrate downstream of the second composition. As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

The first washcoat layer of specific zoned embodiments may extend from the upstream end of the substrate through the range of about 5% to about 95% of the total axial length of the substrate. The second washcoat layer of specific zoned embodiments may extend from the downstream end of the substrate from about 5% to about 95% of the total axial length of the substrate. The zones (and thus the coating layers) may overlap if desired or may be non-overlapping. For example, a first layer may extend from the upstream end towards the downstream end, extending about 5% to about 100%, about 10% to about 90%, or about 20% to about 50% of the substrate length. A second layer may extend from the downstream end towards the upstream end, extending about 5% to about 100%, about 10% to about 90%, or about 20% to about 50% of the substrate length. The first and second layers may be adjacent to each other and not overlay each other. Alternatively, the first and second layers may overlay a portion of each other, providing a third “middle” zone. The middle zone may, for example, extend from about 5% to about 80% of the substrate length. Alternatively, the first layer may extend from the downstream end and the second layer may extend from the upstream end in any of the described configurations.

In some embodiments, the catalyst composition of the first washcoat is present on the catalyst substrate with a loading of at least about 1.0 g/in³. In some embodiments, the catalyst composition of the second washcoat is present on the catalyst substrate with a loading of at least about 1.0 g/in³. In some embodiments, the catalyst substrate is a honeycomb comprising a wall flow filter substrate or a flow through substrate.

### Substrate Coating Process to Afford the Catalyst Article

The above-noted catalyst composition, in the form of carrier particles containing a combination of metal components impregnated therein, is mixed with water to form a slurry for purposes of coating a catalyst substrate, such as a honeycomb-type substrate.

The slurry can be milled to enhance mixing of the particles and formation of a homogenous material. The milling can be accomplished in a ball mill, continuous mill, or other similar equipment, and the solids content of the slurry may be, e.g., about 20-60 wt. %, more particularly about 30-40 wt.. In one embodiment, the post-milling slurry is characterized by a D90 particle size of about 20 to about 30 microns. The D90 is defined as the particle size at which 90% of the particles have a finer particle size.

The slurry is then coated on the catalyst substrate using a washcoat technique known in the art. In one embodiment, the catalyst substrate is dipped one or more times in the slurry or otherwise coated with the slurry. Thereafter, the coated substrate is dried at an elevated temperature (e.g., about 100-150° C.) for a period of time (e.g., about 1-3 hours) and then calcined by heating, e.g., at about 400-700° C., typically for about 10 minutes to about 3 hours. Following drying and calcining, the final washcoat coating layer can be viewed as essentially solvent-free.

After calcining, the catalyst loading can be determined through calculation of the difference in coated and uncoated weights of the substrate as will be apparent to those of skill in the art, the catalyst loading can be modified by altering the slurry rheology. In addition, the coating/drying/calcining process can be repeated as needed to build the coating to the desired loading level or thickness.

The catalyst composition can be applied as a single layer or in multiple layers to generate the catalyst article. In one embodiment, the catalyst is applied in a single layer to generate the catalyst article (e.g., only layer 14 of FIG. 2). In another embodiment, the catalyst composition is applied in multiple layers to afford the catalyst article (e.g., layers 14 and 16 of FIG. 2).

In certain embodiments, the coated substrate is aged, by subjecting the coated substrate to heat treatment. In one particular embodiment, aging is done at a temperature of from about 850° C. to about 1050° C. in an environment of 10 vol. % water in air for 20 hours. Aged catalyst articles are thus provided in certain embodiments. In certain embodiments, particularly effective materials comprise metal oxide-based supports (including, but not limited to substantially 100% ceria supports) that maintain a high percentage (e.g., about 95-100%) of their pore volumes upon aging (e.g., at about 850° C. to about 1050° C., 10 vol. % water in air, 20 hours aging). Accordingly, pore volumes of aged metal oxide-based supports can be, in some embodiments, at least about 0.18 cm³/g, at least about 0.19 cm³/g, or at least about 0.20 cm³/g, e.g., about 0.18 cm³/g to about 0.40 cm³/g. The surface areas of aged metal oxide-based supports (e.g., after aging at the above-noted conditions) can be, for example, within the range of about 20 to about 140 m²/g (e.g., based on aging fresh ceria supports having surface areas of about 40 to about 200 m²/g) or about 50 to about 100 m²/g (e.g., based on aging fresh metal oxide-based supports having surface areas of about 100 to about 180 m²/g). Accordingly, surface areas of preferred aged metal oxide-based supports are in the range of about 50 to about 100 m²/g after aging at temperatures from about 850° C. to about 1050° C. for 20 hours with 10 weight % water in air. In some embodiments, the fresh and aged material can be analyzed by x-ray diffraction, wherein, for example, the average crystallite size ratio of fresh to aged catalyst article can be about 2.5 or less, where aging is at the above-noted conditions.

### EXAMPLES

Aspects of the present invention are more fully illustrated by the following examples, which are set forth to illustrate certain aspects of the present invention and are not to be construed as limiting thereof

### Example 1

### Powder Catalyst Preparation

### Method 1. Sequential Incipient Wetness Impregnation Method.

Ammonium niobium oxalate (C₄H₄NNbO₉) was loaded onto a lanthanum oxide-doped ZrO₂ based support (10% La₂O₃—ZrO₂; 10% by weight of La₂O₃ based on total weight of support) by the incipient wetness impregnation method. After Nb impregnation, the resulting support material was calcined at 550° C. to provide a niobium loading (as Nb₂O₅) of 0.5-20 wt. %. Loading was typically between 5 and 10 wt. %. Rhodium nitrate was then impregnated onto the Nb₂O₅-doped material, followed by calcination at 550° C. The loading of rhodium ranged from 0.5-3 wt.%, and was typically 0.5 or 1 wt.%.

### Method 2. Co-Precipitation Method for Support Preparation and Incipient Wetness Impregnation Method for Rh.

Ammonium niobium oxalate (C₄H₄NNbO₉) was incorporated into a ZrO₂ based support by the co-precipitation method at different Nb₂O₅ levels. The ammonium niobium oxalate was mixed with the Zr precursor, and co-precipitated by adjusting pH using precipitant. After co-precipitation, the resulting niobium-doped ZrO₂ was calcined at 550° C. to provide a niobium loading (as Nb₂O₅) of 0.5-20 wt. %. Loading was typically between 5 and 10 wt. %. Rhodium nitrate was then impregnated onto the Nb₂O₅-doped material, followed by calcination at 550° C. The loading of rhodium ranged from 0.5-3 wt. %, and was typically 0.5 or 1 wt. %.

### Method 3. Co-Impregnation Method.

Niobium oxide (as Nb₂O₅) at 0.5-20 wt. % level and rhodium at 0.5-3 wt. % of Rh level were introduced into a lanthanum oxide-doped ZrO₂ support (10% La₂O₃—ZrO₂) by the co-impregnation method. Ammonium niobium oxalate was mixed with the Rh precursor, and co-impregnated onto support. After co-impregnation, the resulting (Rh-Nb₂O₅)/La₂O₃—ZrO₂, material was calcined at 550° C.

Aging and testing:

The sample was aged at 950/1050° C. under Lean-Rich condition with 10% steam for 5 h in a high throughput experimental reactor. Light-off performance of HC, CO, NOₓ was performed and pollutant conversion determined based on λ-sweep results.

### Results:

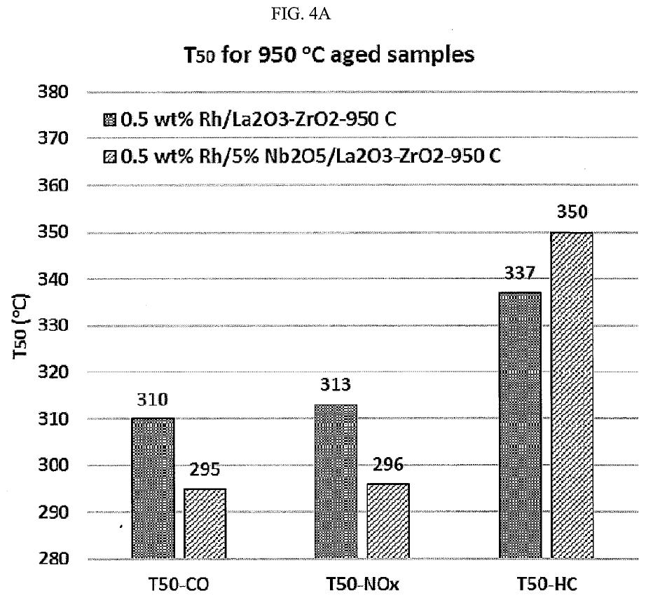

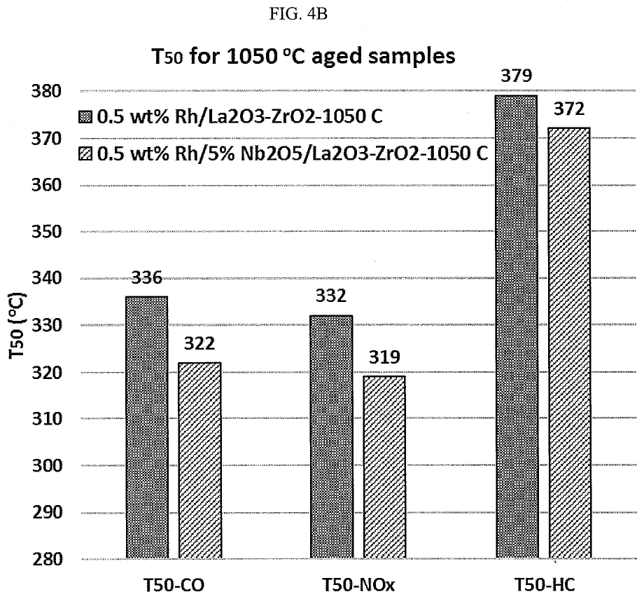

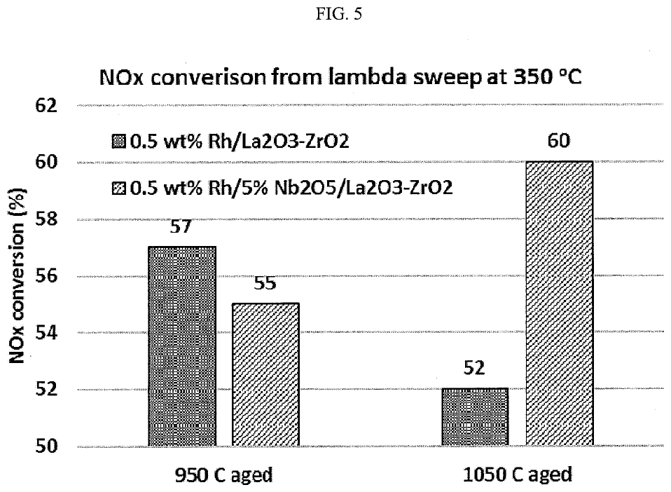

Turning to FIGS. 4A and 4B, it can be seen that, compared to the Rh/La₂O₃—ZrO₂ reference, the inventive Rh/Nb₂O₅—La₂O₃—ZrO₂ catalyst composition showed improved light-off performance after 950/1050° C. aging for CO, NOₓ and HC (except HC light-off after 950° C. aging). As shown in FIG. 5, after 950° C. aging, the NOₓ conversion on Rh/Nb₂O₅—La₂O₃—ZrO₂ catalyst was slightly lower than Rh/La₂O₃-ZrO₂ reference; however, after 1050° C. aging, the NOₓ conversion on Nb₂O₅ doped catalyst was much higher (even higher than the 950° C. aged Rh/Nb₂O₅—La₂O₃—ZrO₂ sample), indicating that the doping of Nb₂O₅ significantly improves the hydrothermal stability of the Rh catalytic species and thus the TWC performance.

### Example 2

### Catalyst Article

### Preparation:

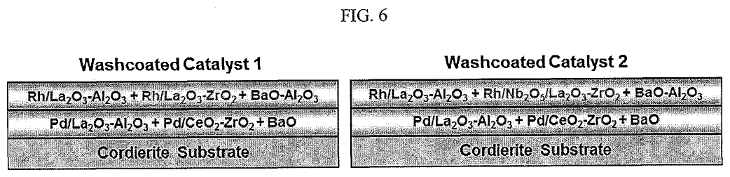

Nb₂O₅—ZrO₂ or Nb₂O₅—Al₂O₃ materials were first prepared following the procedures in Example 1. Afterwards, Rh nitrate was impregnated onto the Nb₂O₅ doped materials without subsequent calcination. Using a chemical fixation method, the Rh impregnated materials were dispersed into slurry for coating onto a cordierite substrate followed by calcination at 550° C. For this example, a typical layered TWC catalyst design was utilized as shown in FIG. 6. Specifically, a cordierite substrate was coated with a bottom layer coating comprising a mixture of palladium supported on lanthanum oxide and aluminum oxide (Pd/La₂O₃—Al₂O₃), palladium supported on an oxygen storage component formed of cerium oxide and zirconium oxide (Pd/CeO₂—ZrO₂), and barium oxide (BaO). The top layer was a combination of rhodium supported on lanthanum oxide and aluminum oxide (Rh/La₂O₃—Al₂O₃), rhodium supported on lanthanum oxide and zirconium oxide (Rh/La₂O₃—ZrO₂), and barium oxide plus aluminum oxide (BaO—Al₂O₃). Washcoated catalyst 1 had the foregoing composition, and is the reference composition. The inventive sample, washcoated catalyst 2, was modified to include niobium in the support of the Rh/La₂O₃—ZrO₂ component.

### Aging and Testing:

The samples were aged at 950° C. on an engine for 50 h; a vehicle test was performed using the reference sample and the inventive sample as a close couple catalyst following FTP-75 cycles (EPA Federal Test Procedure approximating city driving).

### Results on Vehicle:

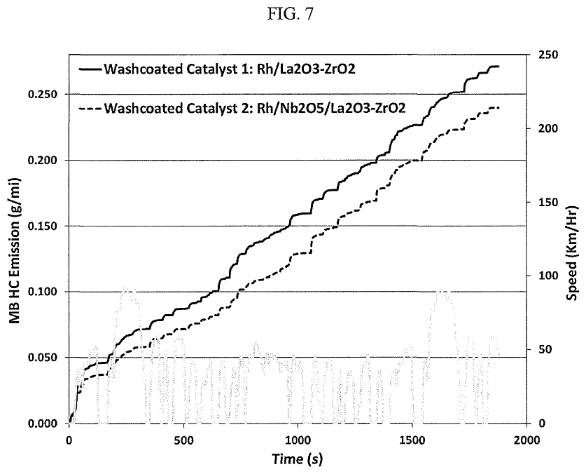

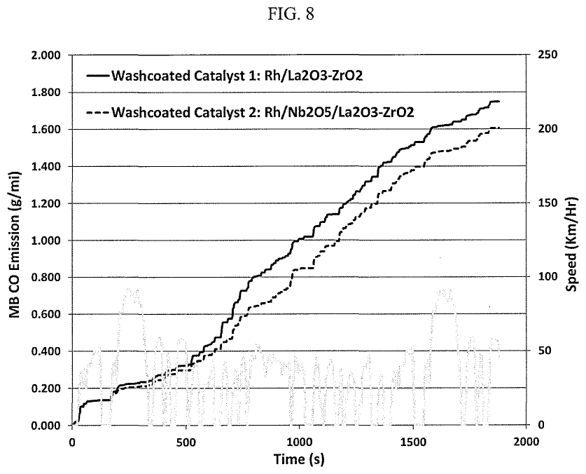

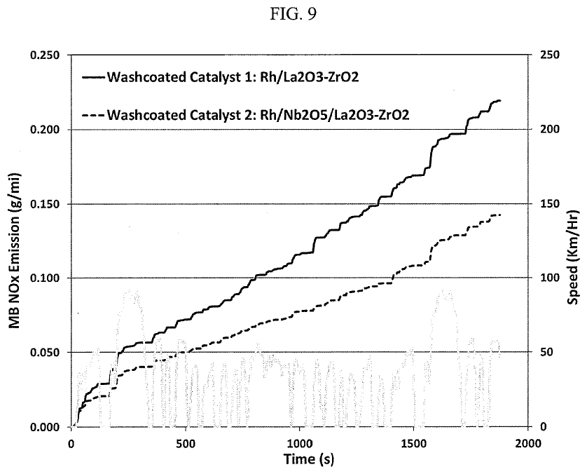

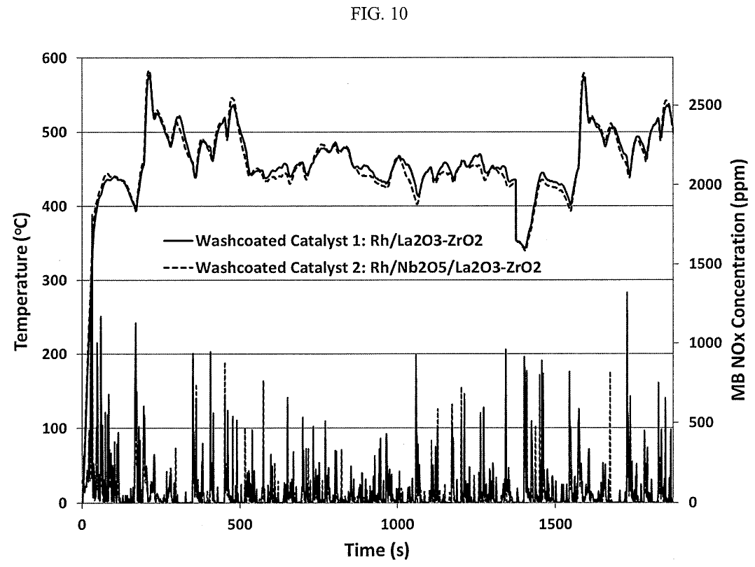

FIGS. 7-9 demonstrate that, compared to a Rh/La₂O₃—ZrO₂ reference, the Rh/Nb₂O₅—La₂O₃—ZrO₂ composition showed ca. 17% less HC emission, 15% less CO emission, and 35% less NOₓ emission in mid bed during FTP-75 test cycles (FIGS. 7, 8 and 9, respectively). As shown in more detail in FIG. 10, during the whole test cycle, the reference and inventive samples had very similar bed temperature, indicating that the vehicle engine was operated under quite similar conditions. The second-by-second mid-bed NOₓ concentration of the exhaust stream after treatment with the Nb₂O₅ doped catalyst composition was nearly always lower than that after treatment with the reference (FIG. 10), including the cold-start region, high space velocity region, and hot-start region. These results clearly indicate the potential for the Rh/Nb₂O₅—La₂O₃—ZrO₂ catalyst composition for TWC application, especially for reduction of NOₓ emissions.

Reference throughout this specification to “one embodiment,” “certain embodiments,” “one or more embodiments” or “an embodiment” means that a particular feature, structure, material, or characteristic described in connection with the embodiment is included in at least one embodiment of the present disclosure. Thus, the appearances of the phrases such as “in one or more embodiments,” “in certain embodiments,” “in some embodiments,” “in one embodiment,” or “in an embodiment” in various places throughout this specification are not necessarily referring to the same embodiment of the present disclosure. Furthermore, the particular features, structures, materials, or characteristics may be combined in any suitable manner in one or more embodiments. All of the various embodiments, aspects, and options disclosed herein can be combined in all variations, regardless of whether such features or elements are expressly combined in a specific embodiment description herein.

Although the embodiments disclosed herein have been described with reference to particular embodiments it is to be understood that these embodiments are merely illustrative of the principles and applications of the present disclosure. It will be apparent to those skilled in the art that various modifications and variations can be made to the methods and apparatus of the present disclosure without departing from the spirit and scope of the disclosure. Thus, it is intended that the present disclosure include modifications and variations that are within the scope of the appended claims and their equivalents, and the above-described embodiments are presented for purposes of illustration and not of limitation. All patents and publications cited herein are incorporated by reference herein for the specific teachings thereof as noted, unless other statements of incorporation are specifically provided.

1. A catalyst composition for treating an exhaust stream of an internal combustion engine, the composition comprising:
a metal oxide-based support including a dopant comprising niobium oxide and at least one refractory metal oxide selected from the group consisting of alumina, zirconia, silica, titania, and combinations thereof; and
a rhodium component supported on the metal oxide-based support.

2. The catalyst composition of claim 1, wherein the metal oxide-based support comprises a further dopant that is a metal oxide selected from the group consisting of lanthanum oxide, neodymium oxide, praseodymium oxide, yttrium oxide, barium oxide, cerium oxide and combinations thereof, preferably wherein the further dopant comprises one or both of lanthanum oxide and barium oxide.

3. The catalyst composition of claim 1, wherein the niobium oxide is present in an amount of about 0.5 to about 20% by weight based on the total weight of the metal oxide based support, preferably in an amount of 1 to 10% by weight based on the total weight of the metal oxide based support.

4. The catalyst composition of claim 1, wherein the rhodium component is present in an amount of 0.01 to 5% by weight based on the total weight of the catalyst composition.

5. The catalyst composition of claim 1, wherein the rhodium component is selected from the group consisting of rhodium, rhodium oxide, and mixtures thereof.

6. The catalyst composition of claim 1, wherein the at least one refractory metal oxide is impregnated with the dopant, or the at least one refractory metal oxide and the dopant are in the form of a co-precipitant.

7. (canceled)

8. A catalyst article for treating an exhaust stream of an internal combustion engine, the catalyst article comprising:
a catalyst substrate; and
a first washcoat of a catalyst composition according to claim 1 on
at least a portion of the catalyst substrate.

9. The catalyst article of claim 8, further comprising a second washcoat of a second, different catalyst composition on at least a portion of the catalyst substrate.

10. The catalyst article of claim 8, wherein the first washcoat is a topcoat, the second washcoat is a bottom coat, and the first washcoat is present over at least a portion of the second washcoat.

11. The catalyst article of claim 8, wherein the first washcoat comprises at least one further catalyst composition comprising at least one refractory metal oxide on a metal oxide-based support selected from the group consisting of alumina, zirconia, silica, titania, and combinations thereof, the at least one further catalyst composition not including the niobium oxide dopant.

12. The catalyst article of claim 11, wherein the at least one further catalyst composition present in the first washcoat includes a rhodium component.

13. The catalyst article of claim 11, wherein the first washcoat comprises a rhodium component, lanthanum oxide, barium oxide, and at least one of zirconium oxide and aluminum oxide.

14. The catalyst article of claim 9, wherein the second washcoat comprises a platinum group metal (PGM), or the second washcoat comprises a PGM on a support that is a refractory metal oxide selected from the group consisting of alumina, zirconia, silica, titania, and combinations thereof, or the second washcoat comprises a PGM on a support that is an oxygen storage component, or comprises lanthanum oxide, cerium oxide, barium oxide, and at least one of zirconium oxide and aluminum oxide.

15.-17. (canceled)

18. The catalyst article of claim 8, wherein the catalyst substrate is a honeycomb comprising a wall flow filter substrate or a flow through substrate.

19. The catalyst article of claim 8, wherein the catalyst composition of the first washcoat is present on the catalyst substrate with a loading of at least 1.0 g/in³.

20. A method for reducing a NOₓ level in an exhaust gas, the method comprising contacting the gas with a catalyst for a time and temperature sufficient to reduce the level of NOx in the gas, wherein the catalyst is a catalyst composition according to claim 1.

21. A method for reducing a HC, CO and/or a NOₓ level in an exhaust gas, the method comprising contacting the gas with a catalyst for a time and temperature sufficient to reduce the level of HC, CO and/or NOₓ in the gas, wherein the catalyst is a catalyst article according to claim 8.

22. A method for preparing the catalyst composition of claim 1, the method comprising:
a) loading a niobium component onto the support by an incipient wetness technique or a co-precipitation method;
b) calcining the resulting niobium impregnated material at a temperature from 400 to 700° C.;
c) impregnating the calcined material with the rhodium component; and
d) calcining the resulting material at a temperature from 400 to 700° C.

23. (canceled)

24. A method for preparing the catalyst composition of claim 1, the method comprising:
a) loading a niobium component and the rhodium component onto the support by a co-impregnation method; and
b) calcining the resulting niobium and rhodium impregnated material at a temperature from 400 to 700° C.

25. The method of claim 22, wherein the niobium component is niobium chloride or ammonium niobium oxalate.

26. A method for preparing the catalyst article of claim 8, the method comprising:
a) loading a niobium component onto the support by an incipient wetness or a co-precipitation technique;
b) impregnating the support material resulting from step a) with a rhodium component;
c) dispersing the resulting rhodium impregnated support as a slurry;
d) coating the slurry onto the substrate by chemical fixation; and
e) calcining the resulting material at a temperature from 400 to 700° C.

27. A four-way filter comprising the catalyst article of claim 8, wherein the catalyst substrate is a particulate filter configured to remove soot and particulate matter, the four-way filter thereby reducing a HC, CO, and/or a NOₓ level in an exhaust gas simultaneously with a reduction in a level of soot and/or particulate matter in the exhaust gas.

28. The method of claims 24, wherein the niobium component is niobium chloride or ammonium niobium oxalate.
